(19) United States
(12) Patent Application Publication
(10) Pub. No.: US 2021/0148721 A1
(43) Pub. Date: May 20, 2021

(54) Intelligent Driving Indication Display System Based On Traffic Indication Devices And Method Thereof

(71) Applicants: Inventec (Pudong) Technology Corporation, Shanghai (CN); Inventec Corporation, Taipei City (TW)

(72) Inventor: Chaucer Chiu, Shanghai (CN)

(21) Appl. No.: 16/721,707

(22) Filed: Dec. 19, 2019

(30) Foreign Application Priority Data
Nov. 18, 2019 (CN) 201911127165.4

(51) Int. Cl. G01C 21/36; G01C 21/34

(52) U.S. Cl. CPC G01C 21/3632; G01C 21/3691; G01C 21/3492

(57) ABSTRACT

An intelligent driving indication display system based on traffic indication devices and a method thereof are disclosed. In the system, a vehicle-mounted device provides destination location information and position information to a server, the server plans a driving route according to the position information and the destination location information, and queries traffic indication devices located on the driving route, and selects the closest traffic indication device from queried traffic indication devices according to the position information, and generates indication information according to the driving route and place information of the selected traffic indication device. The server transmits the indication information to the selected traffic indication device for display, thereby achieving a technical effect of displaying customized driving indication in the selected traffic indication device to reduce driving safety concerns.

### CROSS-REFERENCE TO RELATED APPLICATION

This application claims the benefit of Chinese Application Serial No. 201911127165.4, filed Nov. 18, 2019, which is hereby incorporated herein by reference in its entirety.

### BACKGROUND OF THE INVENTION

### 1. Field of the Invention

The present invention relates to a display system based on traffic indication devices and a method thereof, and more particularly to a system which can provide and display a corresponding driving indication in the closest traffic indication device according to position information of a vehicle-mounted device, and a method thereof.

### 2. Description of the Related Art

Existing vehicles are generally equipped with vehicle-mounted devices which can provide drivers with functions of controlling devices inside the vehicle, monitoring statuses of vehicle components, connecting network, or navigating. The vehicle-mounted device provides various functions for driver to use.

Although the vehicle-mounted device can provide navigation function, the driver must be distracted to watch the navigation path displayed on the vehicle-mounted device during driving. This vehicle navigation manner causes driving safety concerns.

In summary, it can be known that in the prior art, there has been a problem of driving safety concerns of the vehicle navigation provided by the existing vehicle-mounted device, so it is necessary to propose improved technical means to solve this problem.

### SUMMARY OF THE INVENTION

In order to solve the conventional technical problem that the vehicle navigation provided by the existing vehicle-mounted device causes driving safety concerns, the present invention provides an intelligent driving indication display system based on traffic indication devices and a method thereof.

In order to achieve the objective, the present invention provides an intelligent driving indication display system based on traffic indication devices including a vehicle-mounted device, a server, and the traffic indication devices. The vehicle-mounted device comprises a device receiving module, a position information module, and a device transmitting module. The server comprises a server receiving module, a route planning module, a query module, an information generating module, and a server transmitting module.

The device receiving module of the vehicle-mounted device is configured to receive destination location information. The position information module of the vehicle-mounted device is configured to obtain position information of the vehicle-mounted device. The device transmitting module of the vehicle-mounted device is configured to transmit the destination location information and the position information, and periodically transmit the position information.

The server receiving module of the server is configured to receive the destination location information and the position information from the device transmitting module, and periodically receive the position information from the device transmitting module. The route planning module of the server is configured to plan a driving route according to the position information and the destination location information. The query module of the server is configured to query a plurality of the traffic indication devices located on the driving route. The information generating module of the server is configured to select the closest traffic indication device from the plurality of queried traffic indication devices, according to the position information, and generate indication information according to the driving route and place information of the selected traffic indication device. The server transmitting module of the server is configured to transmit the indication information to the selected traffic indication device.

The selected traffic indication device is configured to receive the indication information from the server and display the indication information.

In order to achieve the objective, the present invention provides an intelligent driving indication display method based on traffic indication devices including following steps.

First, the vehicle-mounted device receives destination location information; next, the vehicle-mounted device obtains position information; next, the vehicle-mounted device transmits the destination location information and the position information to the server; next, the server plans a driving route according to the position information and the destination location information; next, the server queries a plurality of the traffic indication devices located on the driving route; next, the vehicle-mounted device periodically transmits the position information to the server; next, the server selects the closest traffic indication device from the plurality of queried traffic indication devices according to the position information, and generates indication information according to the driving route and place information of the selected traffic indication device; next, the server transmits the indication information to the selected traffic indication device; eventually, the selected traffic indication device displays the indication information.

According to the above-mentioned content, the difference between the system and method of the present invention and the conventional technology is that the vehicle-mounted device can provide the destination location information and the position information to the server, the server can plan the driving route according to the position information and the destination location information, and query the traffic indication devices located on the driving route, and select the closest traffic indication device from the queried traffic indication devices according to the position information, and generate the indication information according to the driving route and the place information of the selected traffic indication device, and transmit the indication information to the selected traffic indication device for display.

By the aforementioned technical solution, the system and method of the present invention can achieve the technical effect of displaying customized driving indication information on the traffic indication devices to reduce driving safety concerns.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of an intelligent driving indication display system based on traffic indication devices of the present invention.

FIG. 2A is a schematic view of flat roads with the traffic indication device of the present invention.

FIGS. 2B and 2C are schematic views of display contents of the traffic indication device of the present invention.

FIGS. 3A and 3B are flowcharts of an intelligent driving indication display method based on traffic indication devices of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise”, “include” and “have”, and variations such as “comprises”, “comprising”, “includes”, “including”, “has” and “having” will be acknowledged to imply the inclusion of stated elements but not the exclusion of any other elements.

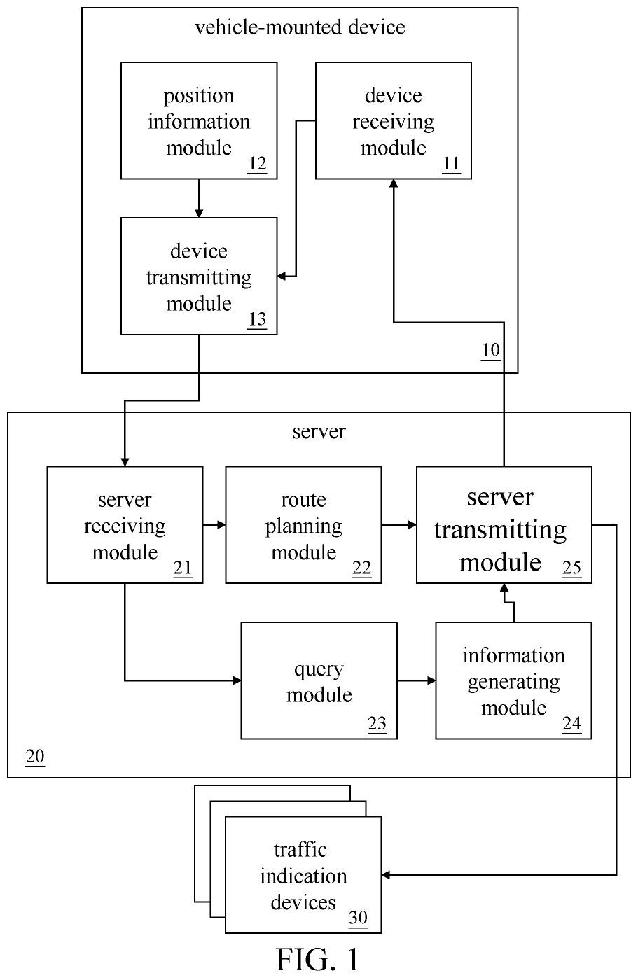

An intelligent driving indication display system based on traffic indication devices of the present invention is described in the following paragraphs. Please refer to FIG. 1, which is a system block diagram of an intelligent driving indication display system based on traffic indication devices of the present invention.

The intelligent driving indication display system based on the traffic indication devices of the present invention comprises a vehicle-mounted device 10, a server 20, and traffic indication devices 30. The vehicle-mounted device 10 comprises a device receiving module 11, a position information module 12 and a device transmitting module 13. The server 20 comprises a server receiving module 21, a route planning module 22, a query module 23, an information generating module 24, and a server transmitting module 25.

The vehicle-mounted device 10 is a device mounted in the vehicle to provide a driver for use during driving. When the driver needs navigation, the driver can input destination location information through a user interface provided by the vehicle-mounted device 10. For example, the destination location information can be an address, a famous landmark, and so on; however, these examples are merely for exemplary illustration, and the application field of the present invention is not limited thereto.

After the driver inputs the destination location information through the user interface provided by the vehicle-mounted device 10, the device receiving module 11 of the vehicle-mounted device 10 receives the destination location information through the user interface, and the position information module 12 of the vehicle-mounted device 10 obtains position information of the vehicle-mounted device 10, and the position information module 12 of the vehicle-mounted device 10 obtains a global positioning coordinate of the vehicle-mounted device 10 in the moment when the device receiving module 11 of the vehicle-mounted device 10 receives the destination location information.

Furthermore, the position information module 12 of the vehicle-mounted device 10 can periodically obtain the position information of the vehicle-mounted device 10. Particularly, the position information module 12 of the vehicle-mounted device 10 can obtain the position information of the vehicle-mounted device every 5 seconds or 10 seconds. However, these examples are merely for exemplary illustration, and the application field of the present invention is not limited thereto.

The vehicle-mounted device 10 is interconnected to the server 20 through a wireless transmission manner, such as Wi-Fi, mobile communication network (such as 3G, 4G, 5G, and so on); however, these examples are merely for exemplary illustration, and the application field of the present invention is not limited thereto. The device transmitting module 13 of the vehicle-mounted device 10 can transmit the destination location information, which is received by the device receiving module 11 of the vehicle-mounted device 10, and the position information, which is obtained by the position information module 12 of the vehicle-mounted device 10, to the server 20. Furthermore, the device transmitting module 13 of the vehicle-mounted device 10 can also periodically transmit the position information, which is obtained periodically by the position information module 12 of the vehicle-mounted device 10, of the vehicle-mounted device.

After the server receiving module 21 of the server 20 can receive the destination location information and the position information from the device transmitting module 13 of the vehicle-mounted device 10, the route planning module 22 of the server 20 can plan a driving route according to the position information and the destination location information. In an embodiment, the manner of planning the driving route can be, for example, a route planning manner based on shortest driving distance requirement, shortest driving time requirement, fuel saving requirement, or traffic jam avoidance requirement; however, these examples are merely for exemplary illustration, and the application field of the present invention is not limited thereto. Furthermore, the above-mentioned driving route planning manner can be referred to prior art, and detailed description is omitted herein.

It should be noted that, after the route planning module 22 of the server 20 plans the driving route according to the position information and the destination location information, the server transmitting module 25 of the server 20 transmits the driving route to the device receiving module 11 of the vehicle-mounted device 10, and after the device receiving module 11 of the vehicle-mounted device 10 receives the driving route from the server transmitting module 25 of the server 20, the display module 14 of the vehicle-mounted device 10 displays the driving route in the digital map, and starts navigation.

After the route planning module 22 of the server 20 plans the driving route according to the position information and the destination location information, the query module 23 of the server 20 queries a plurality of the traffic indication devices 30 located on the driving route, wherein each traffic indication device 30 is mounted on a road to provide and display traffic information for drivers. The displayed traffic information can be, for example, a landmark indication, vehicle speed information, time information, and so on; however, these examples are merely for exemplary illustration, and the application field of the present invention is not limited thereto.

After the query module 23 of the server 20 queries the plurality of traffic indication devices 30 located on the driving route, the information generating module 24 of the server 20 selects the closest traffic indication device 30 from the plurality of queried traffic indication devices 30 according to the destination location information and the position information received by the server receiving module 21 of the server 20 from the device transmitting module 13 of the vehicle-mounted device 10 or the position information periodically received by the device receiving module 11 of the vehicle-mounted device 10 from the device transmitting module 13 of the vehicle-mounted device 10, and the server generates indication information according to the driving route and place information of the selected traffic indication device. In an embodiment, the indication information can comprise text and an image, and for example, the indication information can be the position information of moving straight to the destination, the position information and its related image of turning right to the destination, the position information and its related image of driving on the bridge to the destination, the position information and its related image of getting on/off the freeway to the destination, and so on; however, these examples are merely for exemplary illustration, and the application field of the present invention is not limited thereto.

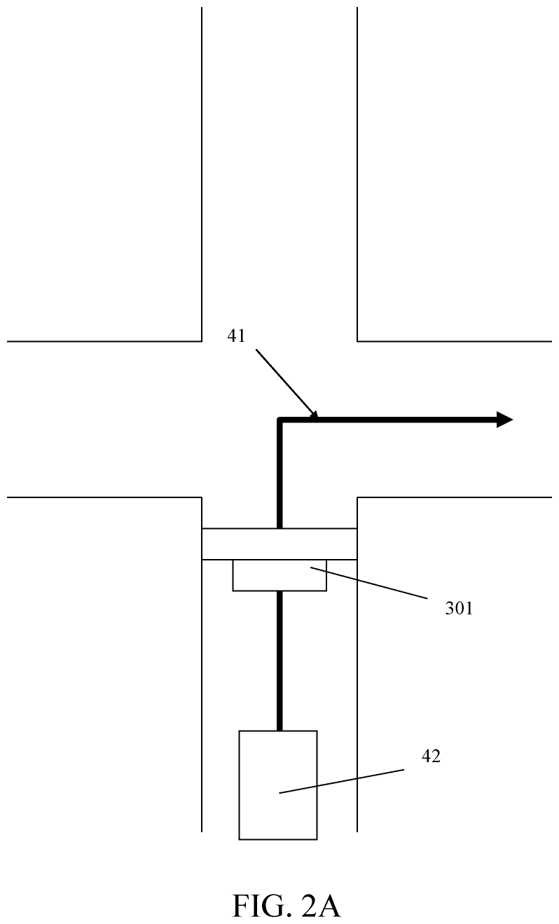

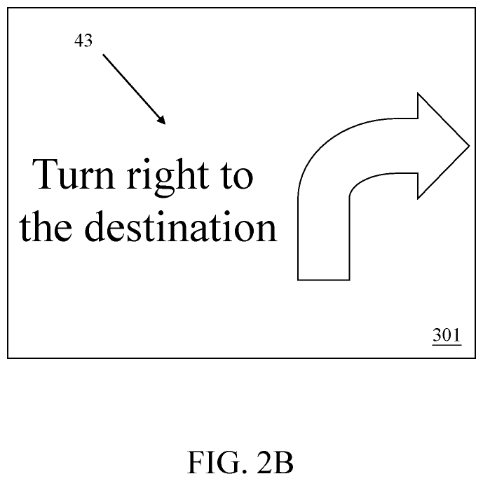

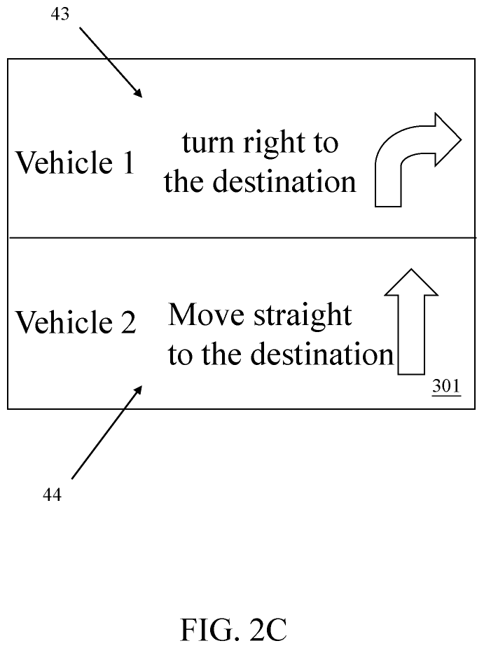

Please refer to FIG. 1 and FIG. 2A, and FIG. 2A is a schematic view of flat roads with the traffic indication device of the present invention.

It is assumed that, after the route planning module 22 of the server 20 plans the first driving route 41 of the first vehicle-mounted device of the first vehicle and the position information module 12 of the first vehicle-mounted device obtains the first position information 42, the device transmitting module 13 of the first vehicle-mounted device transmits the first position information 42 to the server receiving module 21 of the server 20, and the information generating module 24 of the server 20 selects the closest first traffic indication device 301 from the plurality of queried traffic indication devices 30 according to the first position information 42 received by the server receiving module 21 of the server 20 from the device transmitting module 13 of the vehicle-mounted device 10, and the information generating module 24 then generates first indication information according to the driving route and the place information of the closest first traffic indication device 301. In an embodiment, the first indication information is the position information and the related image of turning right to the destination; however, these examples are merely for exemplary illustration, and the application field of the present invention is not limited thereto.

The server transmitting module 25 of the server 20 can transmit the indication information, which is generated by the information generating module 24 of the server 20, to the selected first traffic indication device 301. The server 20 is interconnected to the selected traffic indication device 30 through a wired transmission manner or a wireless transmission manner; for example, the wired transmission manner can be a cable network, an optical network; and the wireless transmission manner can be Wi-Fi, mobile communication network; however, these examples are merely for exemplary illustration, and the application field of the present invention is not limited thereto.

Please refer to FIG. 1 and FIG. 2B, and FIG. 2B is a schematic view of display content of the traffic indication device of the present invention.

After the information generating module 24 of the server 20 generates the first indication information 43, the server transmitting module 25 of the server 20 transmits the first indication information 43, which is generated by the information generating module 24 of the server 20, to the first traffic indication devices 301. After the first traffic indication device 301 receives the first indication information 43 from the server transmitting module 25 of the server 20, the first traffic indication device 301 displays the first indication information 43, so that the driver can watch the first traffic indication device 301 and be aware of turning right in front to the destination.

When the position information of the vehicle-mounted device 10 received by the server receiving module 21 of the server 20 exceeds the position of the first traffic indication device 301 (that is, the vehicle-mounted device 10 has passed the first traffic indication device 301), the information generation module 24 of the server 20 generates a restoration instruction and transmits the restoration instruction to the first traffic instruction device 301 through the server transmission module 25 of the server 20. The first traffic instruction device 301 is restored to display a normal content according to the restoration instruction.

Please refer to FIG. 1 and FIG. 2C, and FIG. 2C is a schematic view of display contents of the traffic indication device of the present invention.

The first traffic indication device 301 can receive the first indication information 43 and the second indication information 44 from the server transmitting module 25 of the server 20 at the same time. The first indication information 43 and the second indication information 44 are used to provide different information to the driver of the first vehicle and the driver of the second vehicle, respectively. After the first traffic indication device 301 receives the first indication information 43 and the second indication information 44 from the server transmitting module 25 of the server 20 at the same time, the first traffic indication device 301 can display the first indication information 43 and the second indication information 44 at the same time, as shown FIG. 2C.

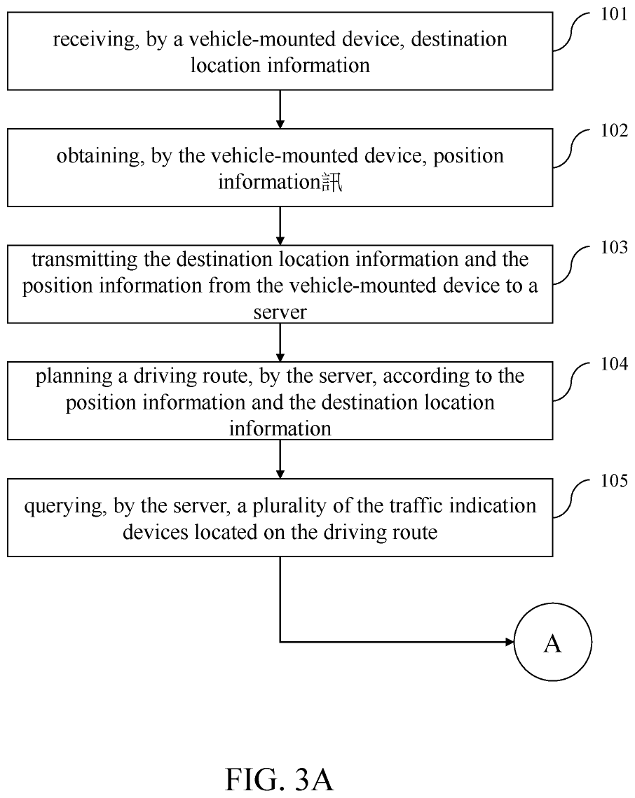

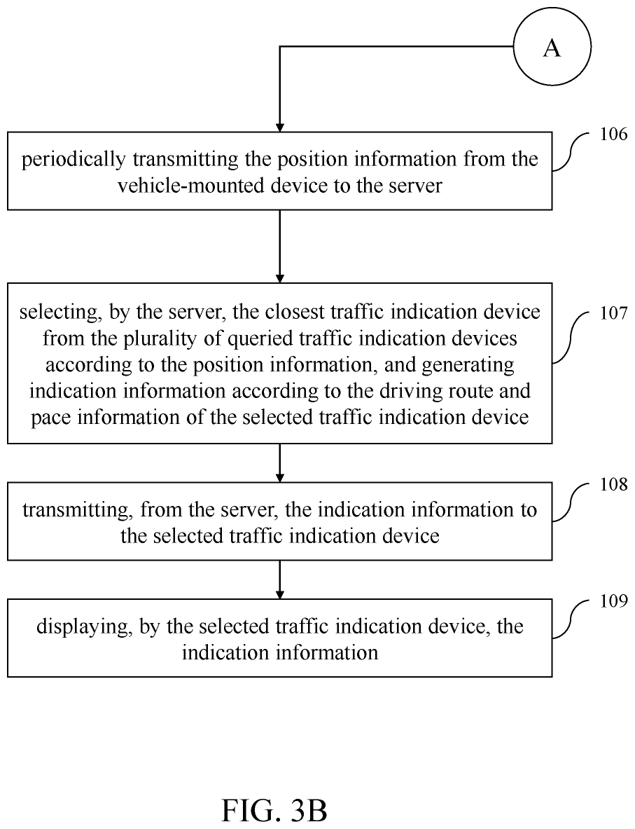

Please refer to FIGS. 3A and 3B, which are flowcharts of an intelligent driving indication display method based on traffic indication devices of the present invention. The method includes steps 101 to 109.

First, in the step 101, a vehicle-mounted device receives destination location information. Next, in the step 102, the vehicle-mounted device obtains position information, and in the step 103, the vehicle-mounted device transmits the destination location information and the position information to a server. In the step 104, the server plans a driving route according to the position information and the destination location information, and in the step 105, the server queries a plurality of the traffic indication devices located on the driving route. In the step 106, the vehicle-mounted device periodically transmits the position information to the server. Next, in the step 107, the server selects the closest traffic indication device from the plurality of queried traffic indication devices according to the position information, and then generates indication information according to the driving route and place information of the selected traffic indication device. Next, in the step 108, the server transmits the indication information to the selected traffic indication device. Eventually, in the step 109, the selected traffic indication device displays the indication information.

According to above-mentioned contents, the difference between the system and method of the present invention and the conventional technology is that the vehicle-mounted device can provide the destination location information and the position information to the server, the server can plan the driving route according to the position information and the destination position information, query the traffic indication devices located on the driving route, and select the closest traffic indication device from the queried traffic indication devices according to the position information, and generate the indication information according to the driving route and the place information of the selected traffic indication device, and then transmit the indication information to the selected traffic indication device for display.

By the technical solution of the present invention, the conventional technical problem that the vehicle navigation provided by the existing vehicle-mounted device may cause driving safety concerns can be solved, and the technical effect of displaying customized driving indication on the traffic indication device to reduce driving safety concerns can be achieved.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An intelligent driving indication display system based on traffic indication devices, comprising:
a vehicle-mounted device comprising:
a device receiving module configured to receive destination location information;
a position information module configured to obtain position information of the vehicle-mounted device; and
a device transmitting module configured to transmit the destination location information and the position information, and periodically transmit the position information; and
a server comprising:
a server receiving module configured to receive the destination location information and the position information from the device transmitting module, and periodically receive the position information from the device transmitting module;
a route planning module configured to plan a driving route according to the position information and the destination location information;
a query module configured to query a plurality of the traffic indication devices located on the driving route;
an information generating module configured to select the closest traffic indication device from the plurality of queried traffic indication devices according to the position information, and generate indication information according to the driving route and place information of the selected traffic indication device; and
a server transmitting module configured to transmit the indication information to the selected traffic indication device; and
the traffic indication devices, of which the selected traffic indication device is configured to receive the indication information from the server and display the indication information.

2. The intelligent driving indication display system according to claim 1, wherein the server transmitting module transmits the driving route to the device receiving module, and the vehicle-mounted device comprises a display module configured to display the driving route.

3. The intelligent driving indication display system according to claim 1, wherein the information generating module generates a restoration instruction, when the position information exceeds the place information of the selected traffic indication device, the server transmitting module transmits the restoration instruction to the selected traffic indication device, and the selected traffic indication device is restored to display a normal content according to the restoration instruction.

4. The intelligent driving indication display system according to claim 1, wherein the indication information comprises text and an image.

5. The intelligent driving indication display system according to claim 1, wherein the selected traffic indication device receives multiple pieces of the indication information from the server and displays the multiple pieces of the indication information at the same time.

6. An intelligent driving indication display method based on traffic indication devices, comprising:
receiving, by a vehicle-mounted device, destination location information;
obtaining, by the vehicle-mounted device, position information;
transmitting the destination location information and the position information from the vehicle-mounted device to a server;
planning a driving route, by the server, according to the position information and the destination location information;
querying, by the server, a plurality of the traffic indication devices located on the driving route;
periodically transmitting the position information from the vehicle-mounted device to the server;
selecting, by the server, the closest traffic indication device from the plurality of queried traffic indication devices according to the position information, and generating indication information according to the driving route and pace information of the selected traffic indication device;
transmitting, from the server, the indication information to the selected traffic indication device; and
displaying, by the selected traffic indication device, the indication information.

7. The intelligent driving indication display method according to claim 6, further comprising:
transmitting the driving route to the vehicle-mounted device, and displaying the driving route by the vehicle-mounted device.

8. The intelligent driving indication display method according to claim 6, further comprising:
when the position information exceeds the place information of the selected traffic indication device, generating a restoration instruction by the server;
transmitting the restoration instruction from the server to the selected traffic indication device; and
restoring the selected traffic indication device to display a normal content according to the restoration instruction.

9. The intelligent driving indication display method according to claim 6, wherein the indication information comprises text and an image.

10. The intelligent driving indication display method according to claim 6, further comprising:
receiving, by the selected traffic indication device, multiple pieces of the indication information from the server, and displaying the multiple pieces of the indication information at the same time.
